(19) United States
(12) Patent Application Publication
(10) Pub. No.: US 2019/0343103 A1
(43) Pub. Date: Nov. 14, 2019

(54) GUIDE FOR FISHING ROD AND FISHING ROD HAVING GUIDE

(71) Applicant: Il Han Kim, Daegu (KR)

(72) Inventor: Il Han Kim, Daegu (KR)

(21) Appl. No.: 15/979,077

(22) Filed: May 14, 2018

(51) Int. Cl. A01K 87/04

(52) U.S. Cl. CPC A01K 87/04

(57) ABSTRACT

Disclosed is a guide for a fishing rod according to an exemplary embodiment of the present invention, which is not permanently coupled to the fishing rod and is detachably formed in the fishing rod so as to be installed in the fishing rod by changing a position of the guide even at any angle desired by a user.

### TECHNICAL FIELD

The present invention relates to a guide for a fishing rod. More particularly, the present invention relates to a guide for a fishing rod which is rotatable in a desired direction.

### BACKGROUND ART

As illustrated in FIG. 1, a guide 10 is fixed to a rod 1 at a predetermined interval so that a fishing line is released from and wound onto a reel smoothly moves in a fishing rod.

In general, the guide 10 is constituted by a guide ring 11 having a through-hole through which the fishing line passes and a connection piece 12 as illustrated in FIG. 2 and the connection piece is fixed to the fishing rod, and as a result, the guide is fixed to the fishing rod.

The guide is fixed to the fishing rod so that the respective fishing rods need to be used, to which the guides are attached in different forms when the fishing line needs to be linearly guided from a handle part to the end of the fishing rod and when the fishing line is positioned above the fishing rod in the handle part, but needs to be guided so as to be positioned below the fishing rod at the end of the fishing rod. Further, it is troublesome to use a fishing rod to which the guide is attached in different forms depending on whether a person is left-handed or right-handed.

### PRIOR ART DOCUMENT

### Patent Document

(Patent Document 0001) Patent Registration No. 10-0937114 “Fishing Line Guide and Guiding Rod Having Same”

### SUMMARY OF THE INVENTION

The present invention has been made in an effort to provide a guide for a rotatable fishing rod.

The present invention has also been made in an effort to provide a guide for a detachable fishing rod.

The present invention has also been made in an effort to provide a fishing rod in which a user is capable of installing a guide in a desired form by providing a guide for a fishing rod which is rotatable and detachable.

The objects and other objects of the present invention may be all achieved by a guide for a fishing rod and the fishing rod having the guide according to the present invention.

An exemplary embodiment of the present invention provides a guide for a fishing rod, including: a body having a pipe shape tapered so as to increase a diameter from one side toward the other side; a guide ring; a connection part which extends from the guide ring and has a bent part; and an attachment part fixing the bent part to the body part.

Further, another exemplary embodiment of the present invention provides a guide for a fishing rod, including: a body having a pipe shape tapered so as to increase a diameter from one side toward the other side; a guide ring; a first connection part which extends from the guide ring and has a bent part; a second connection part which extends from the guide ring and has a bent part; a first attachment part fixing the bent part of the first connection part to one side of the body part; and a second attachment part fixing the bent part of the second connection part to the other side of the body part.

When the guide ring is bisected vertically, a first connection part may extend from a lower part of the guide ring and a second connection part may extend from an upper part of the guide ring.

Yet another exemplary embodiment of the present invention provides a fishing rod including: a pole; and a guide for a fishing rod according to the present invention, which is detachably coupled to the pole.

In the guide for a fishing rod, while one side of the pole is inserted to penetrate a body part of the guide for a fishing rod, the body part moves in a direction of the other side of the pole until being fitted in the pole so as to be fixed to the pole at a first angle and the body part moves in a direction of one side of the pole so as to be separated from the pole and the body part rotates in a predetermined direction while being separated form the pole and thereafter, moves in the direction of the other side of the pole again until being fitted in the pole so as to be coupled to the pole at a second angle different from the first angle.

In addition, the body part of the guide for a fishing rod may have the same elastic force as the pole at a fitting position.

According to the present invention, a guide for a fishing rod is not permanently coupled to the fishing rod and is formed to be detachable to the fishing rod and a user can change a location of the guide at a desired angle so as to install the guide in the fishing rod at any angle desired by the user and change the guide after installation.

### BRIEF DESCRIPTION OF THE DRAWINGS

FIG. 1 is a diagram illustrating a fishing rod to which a guide is attached in the related art.

FIG. 2 is a perspective view of the guide in the related art.

FIG. 3 is a perspective view of a guide according to an exemplary embodiment of the present invention.

FIG. 4 is a diagram illustrating a fishing rod in which the guide is installed according to an exemplary embodiment of the present invention.

FIG. 5 is a diagram illustrating a method for rotating and installing a guide according to an exemplary embodiment of the present invention.

FIG. 6 is a diagram illustrating a state in which a direction of the guide is changed in the fishing rod illustrated in FIG. 4.

FIG. 7 is a perspective view of a guide according to another embodiment of the present invention.

FIG. 8 is a diagram illustrating a fishing rod in which the guide is installed according to another embodiment of the present invention.

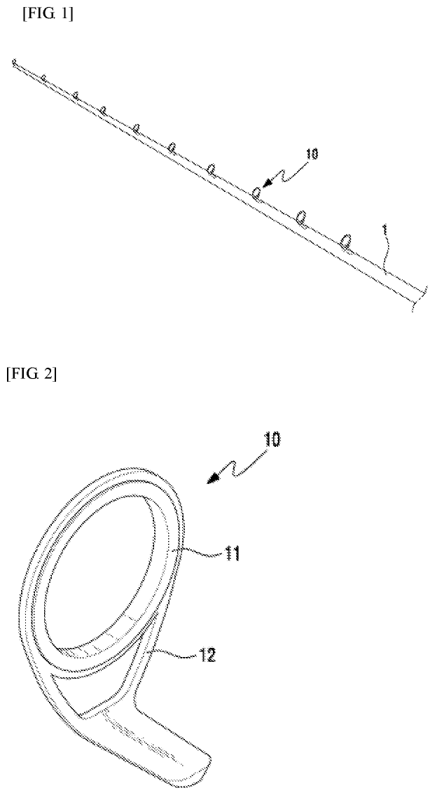

### DETAILED DESCRIPTION

Hereinafter, a guide for a fishing rod and a fishing rod with the guide according to the present invention will be described in detail with reference to the accompanying drawings.

In the following description, only parts required for understanding the fishing rod having a guide and the guide for the fishing rod according to an exemplary embodiment of the present invention will be described and descriptions of other parts may be omitted so as not to disturb the gist of the present invention.

It is also to be understood that terms or words used in the present specification and claims to be described below are not to be interpreted as being restricted to ordinary or dictionary meanings and should be interpreted as meanings and concepts which match the technical spirit of the present invention so as to express the present invention most appropriately.

Throughout the specification, unless explicitly described to the contrary, the word “comprise” and variations such as “comprises” or “comprising”, will be understood to imply the inclusion of stated elements but not the exclusion of any other elements.

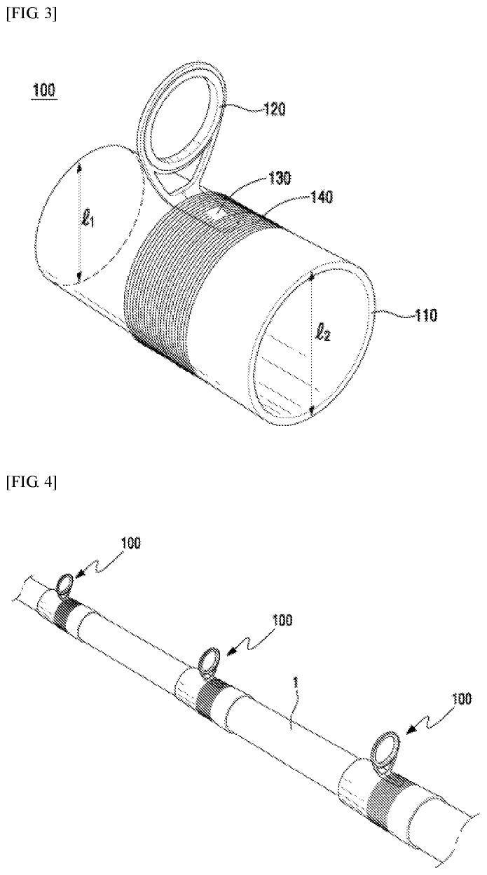

FIG. 3 illustrates a guide for a fishing rod according to an exemplary embodiment of the present invention.

A guide 100 for a fishing rod according to an exemplary embodiment of the present invention is configured to include a body part 110, a guide ring 120, a connection part 130, and an attachment part 140 as illustrated in FIG. 3.

The body part 110 is configured in a pipe shape for detachably attaching the guide 100 for the fishing rod according to an exemplary embodiment of the present invention to a fishing rod.

The pipe-shaped body part 110 is tapered so that a diameter (more precisely, the diameter of an inner diameter) increases from one side to the other side (l₁<l₂), and as a result, a pole 1 could be inserted to the body part 110 while the pole 1 of the fishing rod enters the other side of the body part and the pole exits at the one side, and the body part may be fixed to a pole by fitting the inner diameter of the body part to a position corresponding to an outer diameter of the pole.

Further, it is preferable that the body 110 is formed to have the same elastic force as the pole at a fitting point. To this end, it is preferable that the body part is made of the same material as the pole and a thickness of the body portion is formed to be equal to a length of the pole.

As a result, the body part is configured to have the same elastic force as the pole at the fitting point.

If the body part is not bent or force is applied to the body part in a direction opposite to a direction in which the pole is bent, a problem that the body part or the pole is damaged could be happen. Accordingly, this invention makes the body part have the same elastic force as the pole at the fitting point.

The guide ring 120 as a closed circular ring structure guides the fishing line passing through the guide ring so that the fishing line is not entangled when the fishing line unwound and wound on the reel.

The connection part 130 which is used for connecting the guide ring 120 to the body part extends from the guide ring and is formed with a bent part in a direction opposite to one end connected to the guide ring.

As illustrated in FIG. 3, the bent part is preferably bent at an angle of about 90 degrees so that the guide ring 120 may be positioned in a standing manner with respect to the body 110, but the present invention is not limited thereto.

The attachment part 140 which is used for fixing the bent part of the guide ring 120 to the body part may be formed as a thread, a wire band, or the like as illustrated in FIG. 3. That is, the guide ring 120 may be fixed on a lateral surface of the body part 110 in a standing state by being wound by the thread, the wire band, or the like while the bent part of the connection part is positioned to be in close contact with the lateral surface of the body part and as necessary, epoxy coating may be applied thereon.

The guide 100 for a fishing rod according to an exemplary embodiment of the present invention is configured so as to be fixed by moving toward the other side of the pole 1 until the body part is fitted into the pole while one side of the pole 1 is inserted to penetrate the body part of the guide for a fishing rod.

In FIG. 4, a case in which the three guides 100 for a fishing rod according to an exemplary embodiment of the present invention, which have different inner diameters are positioned in the pole 1 is illustrated.

In FIG. 4, the guide rings 120 of the three guides are installed so as to be positioned on a straight line. However, the guide 100 for a fishing rod according to an exemplary embodiment of the present invention is not permanently fixed to the pole 1 and is detachably installed in the pole 1, and as a result, the user may change an angle of the guide ring as necessary.

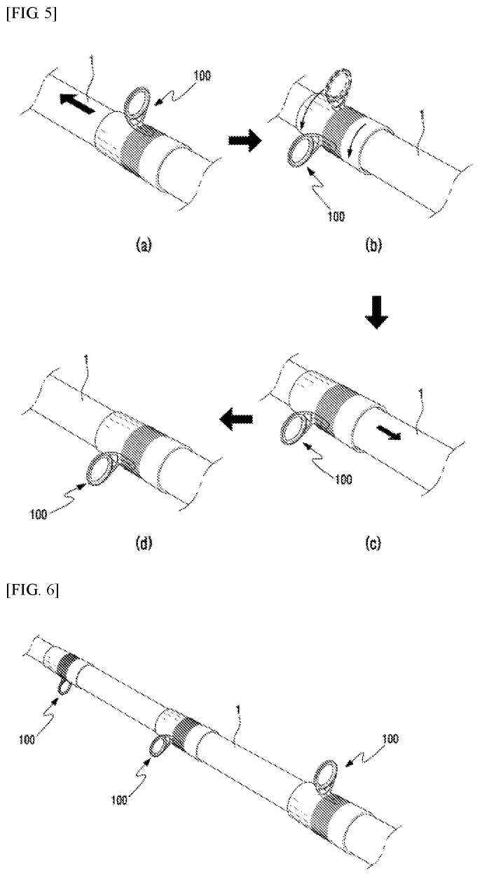

A method for changing the guide ring will be described below in detail with reference to FIG. 5.

That is, as illustrated in FIG. 5A, the body part of the fitted guide is moved in one direction of a smaller diameter to release a fitting state.

Then, as illustrated in FIG. 5B, the user rotates the body part in a desired direction (clockwise or counterclockwise) as desired.

When the angle of the guide ring is changed as much as the user desires, the body part of the guide is moved to the other side of a larger diameter pole as illustrated in FIG. 5C.

When the body part is moved until the body part is fitted into the pole, the guide is moved in a state where the angle of the guide ring is changed at an angle different from the first (that is, the state illustrated in FIG. 5A) as illustrated in FIG. 5D.

By such a method, as illustrated in FIG. 6, the guide may be installed so that the guide ring, which is arranged in the straight line as shown in FIG. 4 rotates counterclockwise from the other side of the pole to one side of the pole.

It can be understood that although FIG. 6 depicts a case in which the guide ring rotates at 90 degrees counterclockwise from the other side to one side of the pole 1, the guide ring may be made to rotate clockwise or rotate at a smaller angle.

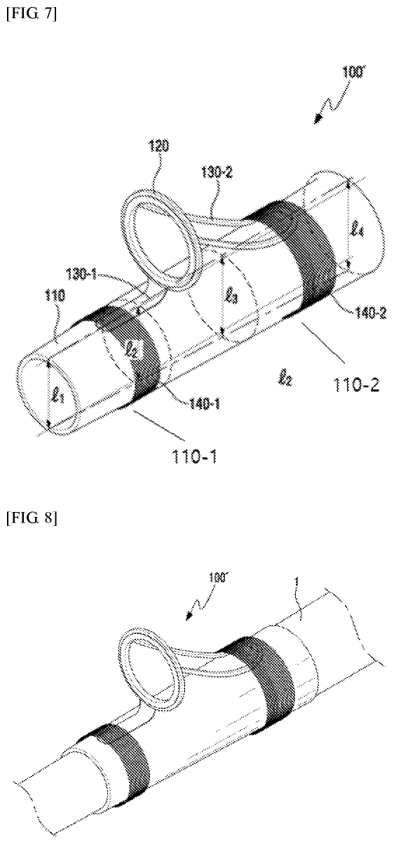

FIG. 7 illustrates a guide 100′ for a fishing rod according to another embodiment of the present invention.

A guide 100′ for a fishing rod according to another embodiment of the present invention is configured to include a guide ring 120, a first connection part 130-1, a second connection part 130-2, a first attachment part 140-1, and a second attachment part 140-2 as illustrated in FIG. 7.

The present invention is characterized in that the guide 100′ for a fishing line according to another embodiment of the present invention illustrated in FIG. 7 includes one body part 110 and a guide ring 120 similarly as the guide 100 for a fishing rod according to an exemplary embodiment of the present invention illustrated in FIG. 4, but the remaining components except for the guide ring, that is, the connection part and the attachment part are each provided in two.

More specifically, the body part 110 has a tapered pipe shape (l₁<l₂<l₃<l₄) in which the diameter increases from one side to the other side similarly to the body part of the guide according to an exemplary embodiment of the present invention described above and may be configured by a pipe having the same material and the same thickness as the pole so as to have the same elastic force as the pole at a fitting position.

The guide ring 120 is also a closed circular ring structure that prevents the fishing line passing through the guide ring from falling to the side similarly as the guide ring of the guide according to an exemplary embodiment of the present invention described above.

However, unlike the guide ring of the guide according to an exemplary embodiment of the present invention, the guide ring of the guide according to another embodiment of the present invention has two connection parts (first connection part 130-1 and second connection part 130-1) for connecting the guide ring to the body part.

The first connection part 130-1 which is used for connecting the guide ring to one side of the body part 110 is formed to extend from the guide ring toward one side of the body part and the second connection part 130-2 which is used for connecting the guide ring to the other side of the body part 110 is formed to face a second body part opposite to the first connection part from the guiding ring.

In this case, it is preferable that the first connection part 130-1 extends from a lower part of the guide ring when the guide ring 120 is bisected vertically and the second connection part 130-2 extends from an upper part of the guide ring so as to more stably support the guide ring.

Further, end portions of the first connection part 130-1 and the second connection part 130-2 are bent so that the first connection part 130-1 and the second connection part 130-2 are in close contact with the lateral surface of the body part similarly to the connection part 130 of the fishing guide 100 according to an exemplary embodiment of the present invention illustrated in FIG. 4.

In this case, it is preferable that the first connection part 130-1 extends vertically from the guide ring 120 and thereafter, is bent at an angle of approximately 90 degrees so that the guide ring 120 may be positioned in the standing state with respect to the body part as illustrated in FIG. 7 and it is preferable that the second connection part 130-2 extends at an oblique angle of approximately 45 degrees toward the second body part 110-2 and thereafter, is bent at an angle of approximately 135 degrees so that the end thereof is parallel to the lateral surface of the body part. However, the angles are exemplary and the angle of the connection part extending from the guide ring and the angle of the bent part are not necessarily limited to the above-exemplified angles.

The first attachment part 140-1 and the second attachment part 140-2 which are used for fixing the bent part of the first connection part and the bent part of the second connection part onto the lateral surfaces of the first body part 110-1 and the second connection part 110-2, respectively may be configured by the thread or wire band. The first attachment part 140-1 and the second attachment part 140-2 may be configured even by any means for fixing the connection part other than the thread or wire band onto the lateral surface of the connection part.

The fishing guide 100′ according to another embodiment of the present invention which is configured as such may be detachably fixed to the pole 1 of the fishing rod as illustrated in FIG. 8 in the same method as the guide 100 for a fishing rod according to an exemplary embodiment of the present invention and set the angle of the guide ring as desired by the user.

However, unlike the guide 100 for a fishing rod according to an exemplary embodiment of the present invention, the fishing guide 100′ according to another embodiment of the present invention includes two first connecting parts 130-1 and second connection parts 130-2 which extend from the guide ring in opposite directions to each other and the first attachment part 140-1 that fixes the first connection part to one side of the body part and the second attachment part 140-2 that fixes the second connection part to the other side of the body part to more stably maintain the position of the guide ring 120 than the guide for a fishing rod according to an exemplary embodiment of the present invention when the same external force is applied.

Up to now, the guide for the fishing rod and the fishing rod with the guide according to the present invention have been described with reference to concrete exemplary embodiments. However, it should be understood that the present invention is not limited to the specific exemplary embodiments and that various changes and modifications can be made therein without departing from the spirit and scope of the invention as claimed.

What is claimed is:

1. A guide for a fishing rod, the guide comprising:
a body having a pipe shape tapered so as to increase a diameter from one side toward the other side;
a guide ring;
a connection part which extends from the guide ring and has a bent part; and
an attachment part fixing the bent part to the body part.

2. A guide for a fishing rod, the guide comprising:
a body having a pipe shape tapered so as to increase a diameter from one side toward the other side;
a guide ring;
a first connection part which extends from the guide ring and has a bent part;
a second connection part which extends from the guide ring and has a bent part;
a first attachment part fixing the bent part of the first connection part to one side of the body part; and
a second attachment part fixing the bent part of the second connection part to the other side of the body part.

3. The guide for a fishing rod, wherein when the guide ring is bisected vertically, the first connection part extends from a lower part of the guide ring, and
the second connection part extends from an upper part of the guide ring.

4. A fishing rod comprising:
a pole; and
a guide for a fishing rod according to claim 1, which is detachably coupled to the pole,
wherein in the guide for a fishing rod, while one side of the pole is inserted to penetrate a body part of the guide for a fishing rod, the body part moves in a direction of the other side of the pole until being fitted in the pole so as to be fixed to the pole at a first angle and the body part moves in a direction of one side of the pole so as to be separated from the pole, and
the body part rotates in a predetermined direction while being separated form the pole and thereafter, moves in the direction of the other side of the pole again until being fitted in the pole so as to be coupled to the pole at a second angle different from the first angle.

5. The fishing rod of claim 4, wherein the body part has the same elastic force as the pole at a fitting position.
